(19) United States
(12) Patent Application Publication
(10) Pub. No.: US 2008/0091868 A1
(43) Pub. Date: Apr. 17, 2008

(54) Method and System for Delayed Completion Coalescing

(76) Inventors: Shay Mizrachi, Hod HaSharon (IL); Eliezer Aloni, Zur Yigal (IL); Uri Tal, Netanya (IL)

Correspondence Address: MCANDREWS HELD & MALLOY, LTD, 500 WEST MADISON STREET, SUITE 3400, CHICAGO, IL, 60661, US

(21) Appl. No.: 11/873,802

(22) Filed: Oct. 17, 2007

Related U.S. Application Data
(60) Provisional application No. 60/829,806, filed on Oct. 17, 2006.

(51) Int. Cl. G06F 13/24

(52) U.S. Cl. 710/263

(57) ABSTRACT

Certain aspects of a method and system for delayed completion coalescing may be disclosed. Exemplary aspects of the method may include accumulating a plurality of bytes of incoming TCP segments in a host memory until a number of the plurality of bytes of incoming TCP segments reaches a threshold value. A completion queue entry (CQE) may be generated to a driver when the plurality of bytes of incoming TCP segments reaches the threshold value and the plurality of bytes of incoming TCP segments may be copied to a user application. The method may also include delaying in a driver, an update of a TCP receive window size until one of the incoming TCP segments corresponding to a particular sequence number is copied to the user application. The CQE may also be generated to the driver when at least one of the incoming TCP segments is received with a TCP PUSH bit SET and the TCP receive window size is greater than a particular window size value.

### CROSS-REFERENCE TO RELATED APPLICATIONS/INCORPORATION BY REFERENCE

This application makes reference to, claims priority to, and claims benefit of U.S. Provisional Application Ser. No. 60/829,806 (Attorney Docket No. 17959US01) filed on Oct. 17, 2006.

The above stated application is hereby incorporated herein by reference in its entirety.

### FIELD OF THE INVENTION

Certain embodiments of the invention relate to network interfaces. More specifically, certain embodiments of the invention relate to a method and system for delayed completion coalescing.

### BACKGROUND OF THE INVENTION

The TCP/IP protocol has long been the common language for network traffic. However, processing TCP/IP traffic may require significant server resources. Specialized software and integrated hardware known as TCP offload engine (TOE) technology may eliminate server-processing constraints. The TOE technology may comprise software extensions to existing TCP/IP stacks that may enable the use of hardware data planes implemented on specialized TOE network interface cards (TNIC). This hardware and/or software combination may allow operating systems to offload all TCP/IP traffic to the specialized hardware on the TNIC, leaving TCP/IP control decisions on the server. Most operating system vendors prefer this approach, which is based on a data-path offload architecture.

The NICs may process TCP/IP operations in software, which may create substantial system overhead, for example, overhead due to data copies, protocol processing and interrupt processing. The increase in the number of packet transactions generated per application network I/O may cause high interrupt load on servers and hardware interrupt lines may be activated to provide event notification. For example, a 64K bit/sec application write to a network may result in 60 or more interrupt generating events between the system and a NIC to segment the data into Ethernet packets and process the incoming acknowledgements. This may create significant protocol processing overhead and high interrupt rates. Another significant overhead may include processing of a packet delivered by the TNIC. This processing may occur in the TNIC driver and a plurality of layers within the operating system. While some operating system features such as interrupt coalescing may reduce interrupts, the corresponding event processing for each server to NIC transaction, and processing of each packet but TNIC driver may not be eliminated.

A TNIC may dramatically reduce the network transaction load on the system by changing the system transaction model from one event per Ethernet packet to one event per application network I/O. For example, the 64K bit/sec application write may become one data-path offload event, moving all packet processing to the TNIC and eliminating interrupt load from the host. A TNIC may be beneficial when each application network I/O translates to multiple packets on the wire, which is a common traffic pattern.

Standard NICs may incorporate hardware checksum support and software enhancements to eliminate transmit-data copies, but may not be able to eliminate receive-data copies that may consume significant processor cycles. A NIC may buffer received packets on the system so that the packets may be processed along with corresponding data coupled with a TCP connection. The receiving system may associate the unsolicited TCP data with the appropriate application and copy the data from system buffers to the destination memory location.

Hardware and software may often be used to support asynchronous data transfers between two memory regions in data network connections, often on different systems. Each host system may serve as a source (initiator) system which initiates a message data transfer (message send operation) to a target system of a message passing operation (message receive operation). Examples of such a system may comprise host servers providing a variety of applications or services and I/O units providing storage oriented and network oriented I/O services. Requests for work, for example, data movement operations including message send/receive operations and remote direct memory access (RDMA) read/write operations may be posted to work queues associated with a given hardware adapter, the requested operation may then be performed. It may be the responsibility of the system which initiates such a request to check for its completion. In order to optimize use of limited system resources, completion queues may be provided to coalesce completion status from multiple work queues belonging to a single hardware adapter. After a request for work has been performed by system hardware, notification of a completion event may be placed on the completion queue. The completion queues may provide a single location for system hardware to check for multiple work queue completions.

The completion queues may support one or more modes of operation. In one mode of operation, when an item is placed on the completion queue, an event may be triggered to notify the requester of the completion. This may often be referred to as an interrupt-driven model. In another mode of operation, an item may be placed on the completion queue, and no event may be signaled. It may be then the responsibility of the request system to periodically check the completion queue for completed requests. This may be referred to as polling for completions.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for delayed completion coalescing, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system for TCP offload, in accordance with an embodiment of the invention.

FIG. 1B is a block diagram of another exemplary system for TCP offload, in accordance with an embodiment of the invention.

FIG. 1C is an alternative embodiment of an exemplary system for TCP offload, in accordance with an embodiment of the invention.

FIG. 2 is a diagram illustrating an exemplary system for TOE flow reception, in accordance with an embodiment of the invention.

FIG. 3A is a block diagram of an exemplary incoming packet scheme that may be utilized in connection with an embodiment of the invention.

FIG. 3B is a block diagram of an exemplary incoming packet handling scheme, in accordance with an embodiment of the invention.

FIG. 4 is a block diagram of an exemplary network system for host software concurrent processing of a single network connection using multiple CPUs, in accordance with an embodiment of the invention.

FIG. 5 is a block diagram of an exemplary adaptive completion threshold scheme, in accordance with an embodiment of the invention.

FIG. 6 is a block diagram illustrating updating of exemplary TCP parameters during a ping-pong test, in accordance with an embodiment of the invention.

FIG. 7 is a flowchart illustrating exemplary steps for delayed completion coalescing, in accordance with an embodiment of the invention.

### DETAILED DESCRIPTION OF THE INVENTION

Certain embodiments of the invention may be found in a method and system for delayed completion coalescing. Aspects of the method and system may comprise accumulating a plurality of bytes of incoming TCP segments in a host memory until a number of the plurality of bytes of incoming TCP segments reaches a threshold value. A completion queue entry (CQE) may be generated to a driver when the plurality of bytes of incoming TCP segments reaches the threshold value and the plurality of bytes of incoming TCP segments may be copied to a user application. The method may also comprise delaying in a driver, an update of a TCP receive window size until one of the incoming TCP segments corresponding to a particular sequence number is copied to the user application. The CQE may also be generated to the driver when at least one of the incoming TCP segments is received with a TCP PUSH bit SET and the TCP receive window size is greater than a particular window size value.

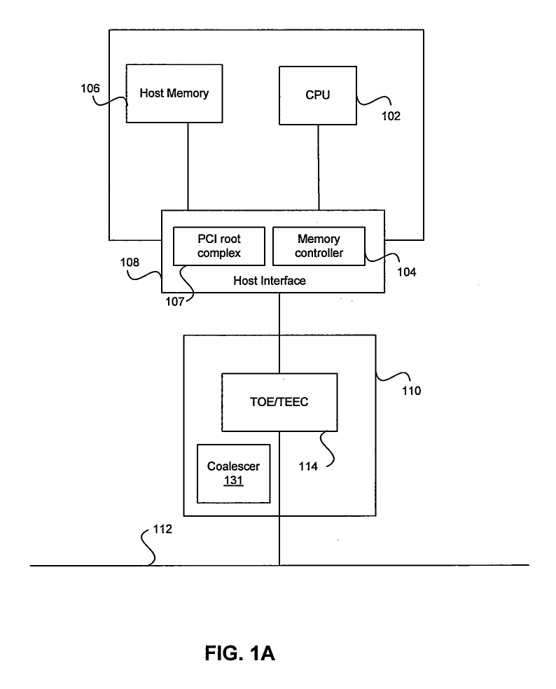

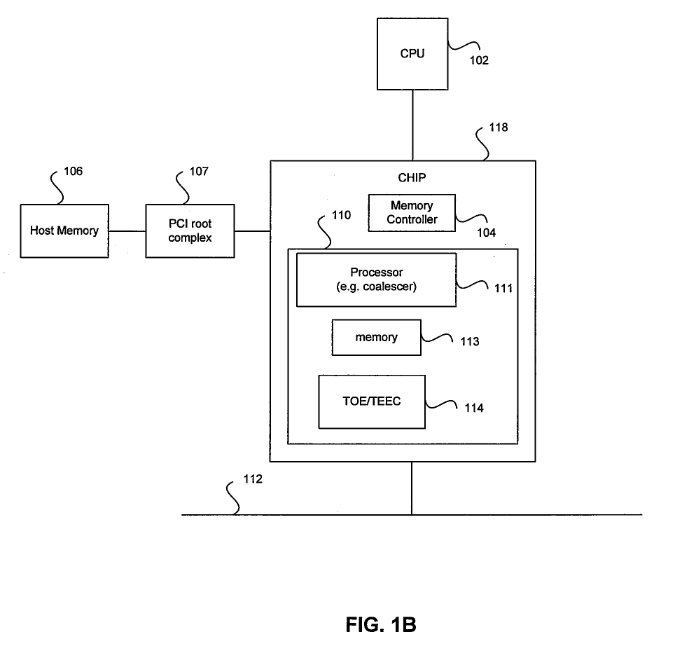

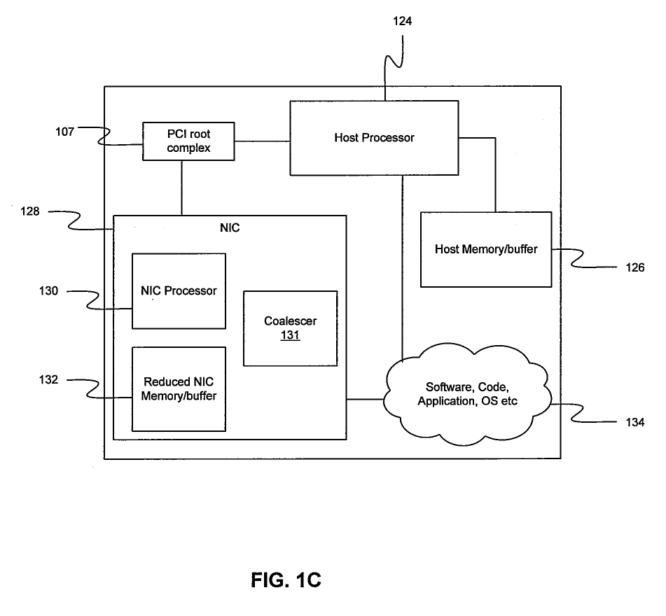

FIG. 1A is a block diagram of an exemplary system for TCP offload, in accordance with an embodiment of the invention. Accordingly, the system of FIG. 1A may be enabled to handle TCP offload of transmission control protocol (TCP) datagrams or packets. Referring to FIG. 1A, the system may comprise, for example, a CPU 102, a host memory 106, a host interface 108, network subsystem 110 and an Ethernet bus 112. The network subsystem 110 may comprise, for example, a TCP-enabled Ethernet Controller (TEEC) or a TCP offload engine (TOE) 114 and a coalescer 131. The network subsystem 110 may comprise, for example, a network interface card (NIC). The host interface 108 may be, for example, a peripheral component interconnect (PCI), PCI-X, PCI-Express, ISA, SCSI or other type of bus. The host interface 108 may comprise a PCI root complex 107 and a memory controller 104. The host interface 108 may be coupled to PCI buses and/or devices, one or more processors, and memory, for example, host memory 106. Notwithstanding, the host memory 106 may be directly coupled to the network subsystem 110. In this case, the host interface 108 may implement the PCI root complex functionally and may be coupled to PCI buses and/or devices, one or more processors, and memory. The memory controller 106 may be coupled to the CPU 104, to the memory 106 and to the host interface 108. The host interface 108 may be coupled to the network subsystem 110 via the TEEC/TOE 114. The coalescer 131 may be enabled to aggregate a plurality of bytes of incoming TCP segments that have been placed to the host memory 106 but have not yet been delivered to a user application.

FIG. 1B is a block diagram of another exemplary system for TCP offload, in accordance with an embodiment of the invention. Referring to FIG. 1B, the system may comprise, for example, a CPU 102, a host memory 106, a dedicated memory 116 and a chip 118. The chip 118 may comprise, for example, the network subsystem 110 and the memory controller 104. The chip set 118 may be coupled to the CPU 102 and to the host memory 106 via the PCI root complex 107. The PCI root complex 107 may enable the chip 118 to be coupled to PCI buses and/or devices, one or more processors, and memory, for example, host memory 106. Notwithstanding, the host memory 106 may be directly coupled to the chip 118. In this case, the host interface 108 may implement the PCI root complex functionally and may be coupled to PCI buses and/or devices, one or more processors, and memory. The network subsystem 110 of the chip 118 may be coupled to the Ethernet 112. The network subsystem 110 may comprise, for example, the TEEC/TOE 114 that may be coupled to the Ethernet bus 112. The network subsystem 110 may communicate to the Ethernet bus 112 via a wired and/or a wireless connection, for example. The wireless connection may be a wireless local area network (WLAN) connection as supported by the IEEE 802.11 standards, for example. The network subsystem 110 may also comprise, for example, an on-chip memory 113. The dedicated memory 116 may provide buffers for context and/or data.

The network subsystem 110 may comprise a processor such as a coalescer 111. The coalescer 111 may be enabled to aggregate a plurality of bytes of incoming TCP segments that have been placed to the host memory 106 but have not yet been delivered to a user application. Although illustrated, for example, as a CPU and an Ethernet, the present invention need not be so limited to such examples and may employ, for example, any type of processor and any type of data link layer or physical media, respectively. Accordingly, although illustrated as coupled to the Ethernet 112, the TEEC or the TOE 114 of FIG. 1A may be adapted for any type of data link layer or physical media. Furthermore, the present invention also contemplates different degrees of integration and separation between the components illustrated in FIGS. 1A-B. For example, the TEEC/TOE 114 may be a separate integrated chip from the chip set 118 embedded on a motherboard or may be embedded in a NIC. Similarly, the coalescer 111 may be a separate integrated chip from the chip set 118 embedded on a motherboard or may be embedded in a NIC. In addition, the dedicated memory 116 may be integrated with the chip set 118 or may be integrated with the network subsystem 110 of FIG. 1B.

In accordance with an embodiment of the invention, a connection completion or delivery of one or more TCP segments in the chip 118 to one or more buffers in the host memory 106 may be delayed till pending bytes count reaches a threshold value or a timeout value. A completion for a single connection may be represented as follows:

1/(single connection completion rate)=(Pending bytes count threshold value)/(connection bandwidth)

Assuming a current interrupt rate of 10K interrupts/sec, an aggregation coefficient may be defined as follows:

Aggregation coefficient=current interrupt rate/[(connection bandwidth)/(pending bytes count threshold value)].

Assuming a connection bandwidth of 1 Gb/s, for example, pending bytes count threshold value=receive window (recv_wnd)/4=64 Kbytes, for example, the aggregation coefficient may be equal to 5. The aggregation coefficient may affect one or more of: deferred procedure call (DPC) processing, number of context switches, cache misses and interrupt rate. In accordance with an embodiment of the invention, the window update in the driver towards far-end may be delayed till the return of all reported completed buffers or till all reported completions are copied to the user application.

FIG. 1C is an alternative embodiment of an exemplary system for TCP offload, in accordance with an embodiment of the invention. Referring to FIG. 1C, there is shown a host processor 124, a host memory/buffer 126, a software algorithm block 134 and a NIC block 128. The NIC block 128 may comprise a NIC processor 130, a processor such as a coalescer 131 and a reduced NIC memory/buffer block 132. The NIC block 128 may communicate with an external network via a wired and/or a wireless connection, for example. The wireless connection may be a wireless local area network (WLAN) connection as supported by the IEEE 802.11 standards, for example.

The NIC 126 may be coupled to the host processor 124 via the PCI root complex 107. The NIC 126 may be coupled to PCI buses and/or devices, one or more processors, and memory, for example, host memory 106 via the PCI root complex 107. Notwithstanding, the host memory 106 may be directly coupled to the NIC 126. In this case, the host interface 108 may implement the PCI root complex functionally and may be coupled to PCI buses and/or devices, one or more processors, and memory. The coalescer 131 may be a dedicated processor or hardware state machine that may reside in the packet-receiving path. The host TCP stack may comprise software that enables management of the TCP protocol processing and may be part of an operating system, such as Microsoft Windows or Linux. The coalescer 131 may comprise suitable logic, circuitry and/or code that may be enabled to aggregate a plurality of bytes of incoming TCP segments that have been placed to the host memory 106 but have not yet been delivered to a user application.

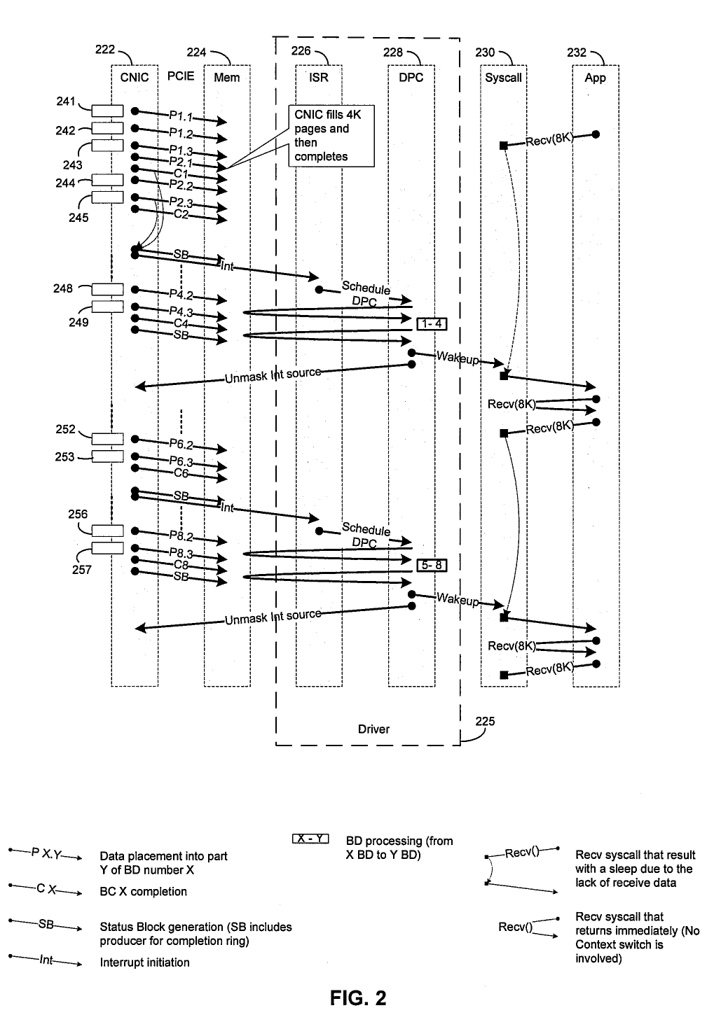

FIG. 2 is a diagram illustrating an exemplary system for TOE flow reception, in accordance with an embodiment of the invention. Referring to FIG. 2, there is shown a CNIC 222 that may be enabled to receive a plurality of TCP segments 241, 242, 243, 244, 245, 248, 249, 252, 253, 256 and 257.

The CNIC 222 may be enabled to write the received TCP segments into one or more buffers in the host memory 224 via a peripheral component interconnect express (PCIe) interface, for example. When an application receive buffer is available, the CNIC 222 may be enabled to place the payload of the received TCP segment into a preposted buffer. If an application receive buffer is not available, the CNIC 222 may be enabled to place the payload of the received TCP segment into a buffer selected from a global buffer pool that may be shared for all TCP connections on the same CPU/port.

For example, the CNIC 222 may be enabled to place the payload of the received TCP segment 241 into part 1 of a buffer 1 within host memory 224 and may be denoted as P1.1, for example. The CNIC 222 may be enabled to place the payload of the received TCP segment 242 into part 2 of buffer 1 and may be denoted as P1.2, for example. The CNIC 222 may be enabled to place the payload of the received TCP segment 243 into part 3 of buffer 1 and may be denoted as P1.3, for example. The remaining payload of the received TCP segment may be written to the following buffer. The CNIC 222 may be enabled to place the remaining payload of the received TCP segment 243 into part 1 of a buffer 2 and may be denoted as P2.1, for example.

The CNIC 222 may be enabled to generate a completion queue element (CQE) C1 to host memory 224 when buffer 1 in host memory 224 is full. The CNIC 222 may be enabled to generate C1 after placing the remaining payload of the received TCP segment 243 into part 1 of a buffer 2. Similarly, the CNIC 222 may be enabled to place the payload of the received TCP segment 244 into part 2 of buffer 2 and may be denoted as P2.2, for example. The CNIC 222 may be enabled to place the payload of the received TCP segment 245 into part 3 of buffer 2 and may be denoted as P2.3, for example. The CNIC 222 may be enabled to generate a CQE C2 to host memory 224 when buffer 2 in host memory 224 is full.

The completion queue (CQ) update may be reported to the driver 225 via a host coalescing (HC) mechanism. The coalescing may be based on a number of pending CQEs that were updated to the CQ but not yet indicated for the time period since the last status block update. A status block may comprise a driver 225 that may be enabled to determine whether a particular completion queue has been updated. A plurality of status blocks may be coalesced based on one or more modes per protocol in each status block segment. The status block (SB) update may comprise writing a SB over PCIe to the host memory 224. The SB update may be followed by an interrupt request, which may be aggregated.

The CNIC 222 may be enabled to generate an interrupt via the interrupt service routine (ISR) 226 to the driver 225. The CNIC 222 may notify the driver 225 of previous placement of completion operation. The ISR 226 may be enabled to verify the interrupt source and schedule a deferred procedure call (DPC) 228. The DPC 228 may be enabled to read and process the SB to determine an update in the CQ. The DPC 228 may be enabled to process any new CQEs in order to update socket information for any new receive payloads for the user application. While the DPC 228 is processing the plurality of CQEs, the CNIC 222 may be enabled to place the payload of the received TCP segment 248 into part 2 of buffer 4 and may be denoted as P4.2, for example. The CNIC 222 may be enabled to place the payload of the received TCP segment 249 into part 3 of buffer 4 and may be denoted as P4.3, for example. The CNIC 222 may be enabled to generate a CQE C4 to host memory 224 when buffer 4 in host memory 224 is full.

If a user application 232 is already waiting for an indication, then the DPC 228 may send a wakeup signal to the system call (syscall) 230 in order to wake up the user application 232. The syscall 230 may enter a sleep mode and may be woken up by the DPC 228. Upon waking up, the syscall 230 may return to the user application 232 with the receive data. There may be two different scenarios with different costs for calling the receive syscall 230. In one case, the user application 232 may call to receive data when no data is pending. In this case, the syscall 230 may enter a sleep mode and may be woken up by the DPC 228. In a second case, the user application 232 may call to receive data when data is already present. In such a case, the data may be returned immediately.

The plurality of TCP segments 152, 153, 156 and 157 may be placed into corresponding buffers in host memory 224. A plurality of CQEs C6 to C8 may be generated to the host memory 224. The corresponding SB updates may comprise writing a SB over PCIe to the host memory 224 and may be followed by an interrupt request via the ISR 226 to the driver 225. The DPC 228 may be enabled to processes any new CQEs in order to update socket information for any new receive payloads for the user application 232.

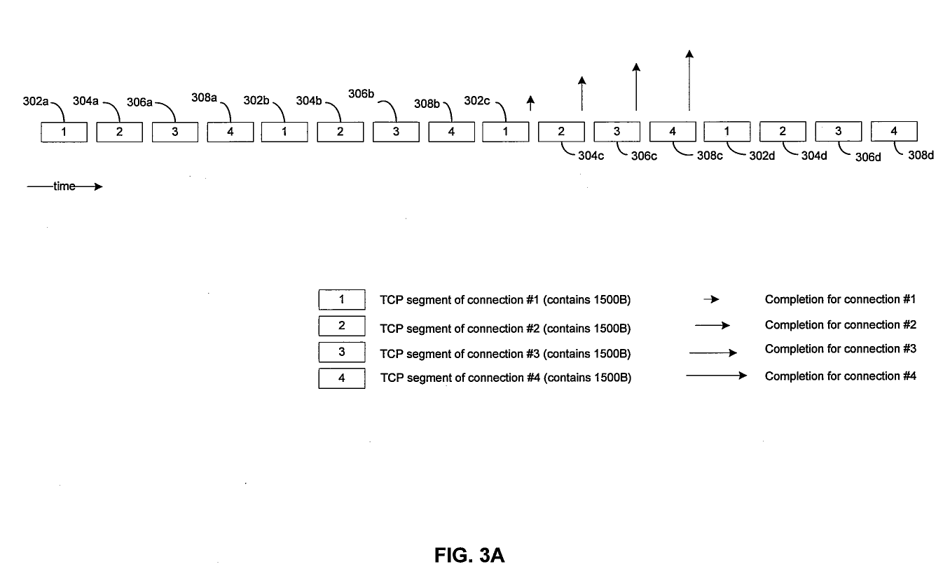

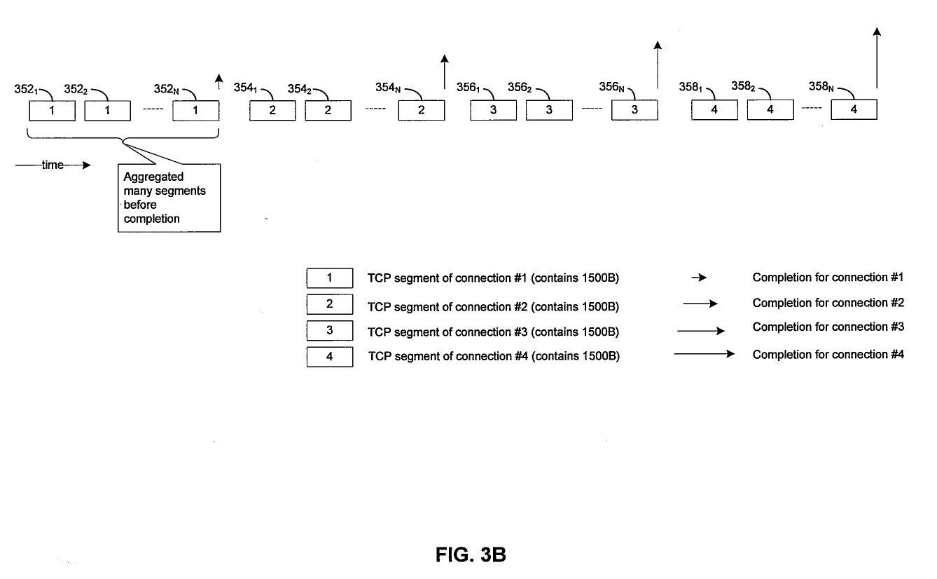

FIG. 3A is a block diagram of an exemplary incoming packet scheme that may be utilized in connection with an embodiment of the invention. Referring to FIG. 3A, there is shown a plurality of received TCP segments 302a, 304a, 306a, 308a, 302b, 304b, 306b, 308b, 302c, 304c, 306c, 308c, 302d, 304d, 306d and 308d associated with a plurality of connections. FIG. 3A illustrates exemplary TOE flow reception comprising delivery after one or more buffers are completed.

The plurality of received TCP segments 302a, 302b, 302c and 302d may be associated with connection 1. The plurality of received TCP segments 304a, 304b, 304c and 304d may be associated with connection 2. The plurality of received TCP segments 306a, 306b, 306c and 306d may be associated with connection 3. The plurality of received TCP segments 308a, 308b, 308c and 308d may be associated with connection 4.

The CNIC 222 may be enabled to place the payloads of the received TCP segments as they arrive into a buffer in the host memory 224. The CNIC 222 may be enabled to generate a CQE to host memory 224 when the buffer in host memory 224 is full. For example, a CQE for connection 1 may be generated after placing the payload of TCP segment 302c in a buffer in host memory 224. Similarly, a CQE for connection 2 may be generated after placing the payload of TCP segment 304c in a buffer in host memory 224. A CQE for connection 3 may be generated after placing the payload of TCP segment 306c in a buffer in host memory 224. A CQE for connection 4 may be generated after placing the payload of TCP segment 308c in a buffer in host memory 224.

FIG. 3B is a block diagram of an exemplary incoming packet handling scheme, in accordance with an embodiment of the invention. Referring to FIG. 3B, there is shown a plurality of received TCP segments 352_{1,2, . . . , N} associated with connection 1, 354_{1,2, . . . , N} associated with connection 2, 356_{1,2 . . . , N} associated with connection 3 and 358_{1,2, . . . , N} associated with connection 4. Referring to FIG. 3B, a plurality of received TCP segments may be aggregated over a plurality of received buffers.

In accordance with an embodiment of the invention, the CNIC 222 may be enabled to place the payloads of the received TCP segments 352_{1,2, . . . , N} into a buffer in the host memory 224 before generating a CQE to host memory 224 when the buffer in host memory 224 is full. Similarly, the CNIC 222 may be enabled to place the payloads of the received TCP segments 354_{1,2, . . . , N} into a buffer in the host memory 224 before generating a CQE to host memory 224 when the buffer in host memory 224 is full. The CNIC 222 may be enabled to place the payloads of the received TCP segments 356_{1,2, . . . , N} into a buffer in the host memory 224 before generating a CQE to host memory 224 when the buffer in host memory 224 is full. The CNIC 222 may be enabled to place the payloads of the received TCP segments 358_{1,2, . . . , N} into a buffer in the host memory 224 before generating a CQE to host memory 224 when the buffer in host memory 224 is full.

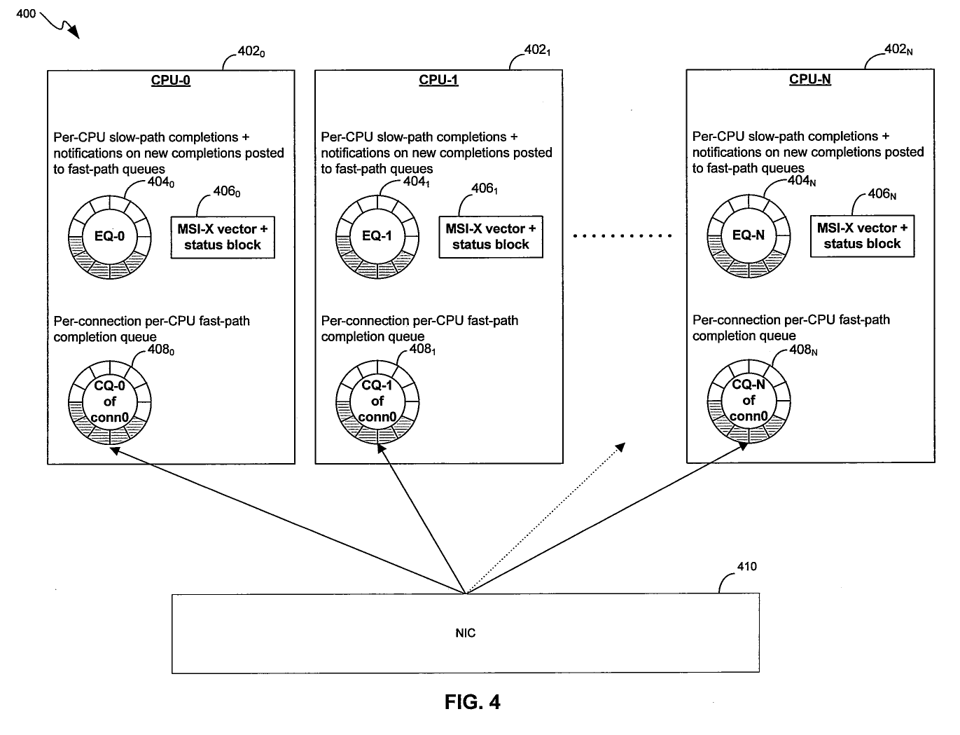

FIG. 4 is a block diagram of an exemplary network system for host software concurrent processing of a single network connection using multiple CPUs, in accordance with an embodiment of the invention. Referring to FIG. 4, there is shown a network system 400. The network system 400 may comprise a plurality of interconnected processors or central processing units (CPUs), CPU-0 402₀, CPU-1 402₁ . . . CPU-N 402_{N} and a NIC 410. Each CPU may comprise an event queue (EQ), a MSI-X interrupt and status block, and a completion queue (CQ) associated with a particular connection. For example, CPU-0 402₀ may comprise an EQ-0 404₀, a MSI-X vector and status block 406₀, and a CQ-0 for connection-0 408₀. Similarly, CPU-1 402₂ may comprise an EQ-1 408₁, a MSI-X vector and status block 406₁, and a CQ-1 for connection-0 408₁. CPU-N 402_{N} may comprise an EQ-N 404_{N}, a MSI-X vector and status block 406_{N}, and a CQ-N for connection-0 408_{N}.

Each event queue (EQ), for example, EQ-0 404₀, EQ-1 404₁ . . . EQ-N 404_{N} may be enabled to queue events from underlying peers and from trusted applications. Each event queue, for example, EQ-0 404₀, EQ-1 404₁ . . . EQ-N 404_{N} may be enabled to encapsulate asynchronous event dispatch machinery which may extract events from the queue and dispatch them. In one embodiment of the invention, the EQ, for example, EQ-0 404₀, EQ-1 404₁ . . . EQ-N 404_{N} may be enabled to dispatch or process events sequentially or in the same order as they are enqueued.

The plurality of MSI-X and status blocks for each CPU, for example, MSI-X vector and status block 406₀, 406₁ . . . 406_{N} may comprise one or more extended message signaled interrupts (MSI-X). The message signaled interrupts (MSIs) may be in-band messages that may target an address range in the host bridge unlike fixed interrupts. Since the messages are in-band, the receipt of the message may be utilized to push data associated with the interrupt. Each of the MSI messages assigned to a device may be associated with a unique message in the CPU, for example, a MSI-X in the MSI-X and status block 406₀ may be associated with a unique message in the CPU-0 402₀. The PCI functions may request one or more MSI messages. In one embodiment of the invention, the host software may allocate fewer MSI messages to a function than the function requested.

Extended MSI (MSI-X) may comprise the capability to enable a function to allocate more messages, for example, up to 2048 messages by making the address and data value used for each message independent of any other MSI-X message. The MSI-X may also enable software to choose to use the same MSI address and/or data value in multiple MSI-X slots, for example, when the system allocates fewer MSI-X messages to the device than the device requested.

In an exemplary embodiment of the invention, the MSI-X interrupts may be edge triggered since the interrupt may be signaled with a posted write command by the device targeting a pre-allocated area of memory on the host bridge. However, some host bridges may have the ability to latch the acceptance of an MSI-X message and may effectively treat it as a level signaled interrupt. The MSI-X interrupts may enable writing to a segment of memory instead of asserting a given IRQ pin. Each device may have one or more unique memory locations to which MSI-X messages may be written. The MSI interrupts may enable data to be pushed along with the MSI event, allowing for greater functionality. The MSI-X interrupt mechanism may enable the system software to configure each vector with an independent message address and message data that may be specified by a table that may reside in host memory. The MSI-X mechanism may enable the device functions to support two or more vectors, which may be configured to target different CPUs to increase scalability.

The plurality of completion queues associated with a single connection, connection-0, for example, CQ-0 408₀, CQ-1 408₁ . . . CQ-N 408_{N} may be provided to coalesce completion status from multiple work queues belonging to NIC 410. The completion queues may provide a single location for NIC 410 to check for multiple work queue completions. The NIC 410 may be enabled to place a notification of one or more task completions on at least one of the plurality of completion queues per connection, for example, CQ-0 for connections 408₀, CQ-1 for connection-408₁ . . . , CQ-N for connections 408_{N} after completion of one or more tasks associated with the received I/O request.

In accordance with an embodiment of the invention, host software performance enhancement for a single network connection may be achieved in a multi-CPU system by distributing the completions between the plurality of CPUs, for example, CPU-0 402₀, CPU-1 402₁ . . . CPU-N 402_{N}. In another embodiment, an interrupt handler may be enabled to queue the plurality of events on deferred procedure calls (DPCs) of the plurality of CPUs, for example, CPU-0 402₀, CPU-1 402₁ . . . CPU-N 402_{N} to achieve host software performance enhancement for a single network connection. The plurality of DPC completion routines of the stack may be performed for a plurality of tasks concurrently on the plurality of CPUs, for example, CPU-0 402₀, CPU-1 402₁ . . . CPU-N 402_{N}. In another embodiment of the invention, each CPU may comprise a plurality of completion queues and the plurality of task completions may be distributed between the plurality of CPUs, for example, CPU-0 402₀, CPU-1 402₁ . . . CPU-N 402_{N} so that there is a decrease in the amount of cache misses.

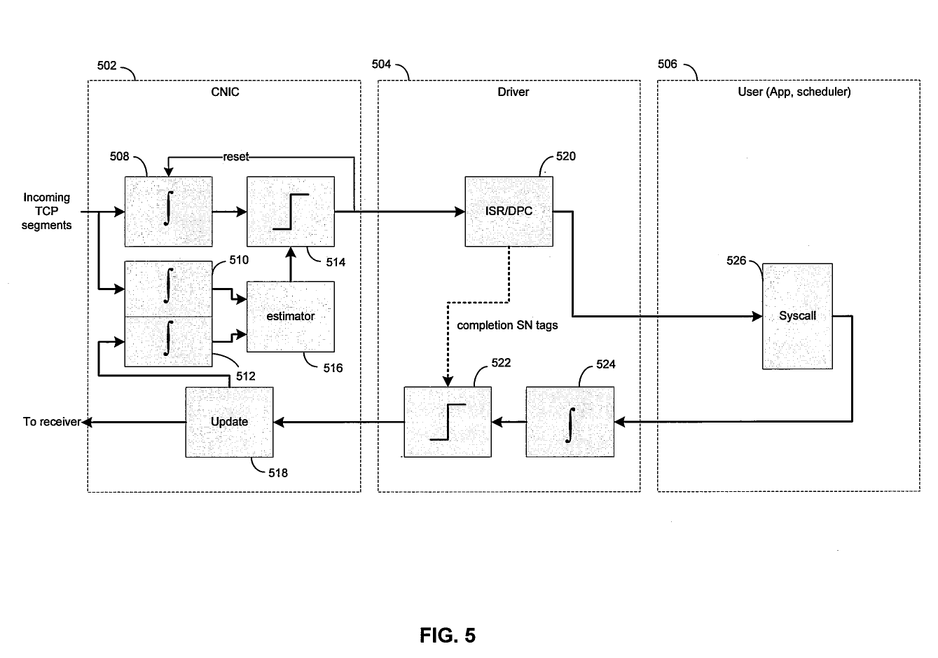

FIG. 5 is a block diagram of an exemplary adaptive completion threshold scheme, in accordance with an embodiment of the invention. Referring to FIG. 5, there is shown a CNIC 502, a driver 504 and a user application 506. The CNIC 502 may comprise a plurality of aggregate blocks 508, 510 and 512, a threshold block 514, an estimator 516 and a update block 518. The driver 504 may comprise a ISR/DPC block 520, a aggregate block 524 and a threshold block 522. The user application 506 may comprise a syscall 526.

The CNIC 502 may be enabled to write the incoming TCP segments in to one or more buffers in the host memory 106. When an application receive buffer is available, the CNIC 502 may be enabled to place the payload of the received TCP segment into a pre-posted buffer. If an application receive buffer is not available, the CNIC 502 may be enabled to place the payload of the received TCP segment into a buffer selected from a global buffer pool that may be shared for all TCP connections on the same CPU/port.

The aggregate block 508 may be enabled to aggregate a plurality of bytes of incoming TCP segments that have been placed in the host memory 106 but have not yet been delivered to a user application 506. The threshold block 514 may comprise a completion threshold value that may depend on a connection rate. If the number of aggregated plurality of bytes of TCP segments in the aggregate block 508 is below the completion threshold value, the aggregate block 508 may continue to aggregate the plurality of bytes of incoming TCP segments. If the number of aggregated plurality of bytes of TCP segments in the aggregate block 508 is not below a completion threshold value, the CNIC 502 may generate a completion queue element (CQE) to the driver 504.

In accordance with an embodiment of the invention, the aggregate block 508 may be enabled to aggregate a plurality of bytes of incoming TCP segments that have been placed to the host memory 106 but have not yet been delivered to a user application 506. The threshold block 514 may comprise a timeout value. If the number of bytes of incoming TCP segments that have been placed to the host memory 106 but have not yet been delivered to a user application 506 have been aggregated for a time period above the timeout value, the CNIC 502 may generate a completion queue element (CQE) to the driver 504.

The ISR/DPC block 520 may be enabled to receive the generated CQEs from the CNIC 502. The CQEs may be reported to the driver 504 via a host coalescing (HC) mechanism. The coalescing may be based on a number of pending CQEs that were updated to CQ but not yet indicated and the time period since the last status block update. A plurality of status blocks may be coalesced based on one or more modes per protocol in each status block segment. The SB update may comprise writing a SB over PCIe to the host memory 106. The SB update may be followed by an interrupt request, which may be aggregated. The user application 506 may request more incoming TCP segments when a CQE is posted to the driver 504.

The CNIC 502 may notify the driver 504 of previous placement of completion operations. The ISR/DPC block 520 may be enabled to verify the interrupt source and schedule a DPC. The ISR/DPC block 520 may be enabled to read and process the SB to determine an update in the CQ. The ISR/DPC block 520 may be enabled to process any new CQEs in order to update socket information for any new receive payloads for the user application 506.

The application receive system call 526 may be enabled to copy received data to user application 506. The user application 506 may be enabled to update the advertised window size and communicate the updated advertised window size to the driver 504. The aggregate block 524 may be enabled to aggregate the number of bytes of incoming TCP segments that were copied to the user application 506.

The threshold block 522 may comprise a threshold value based on sequence number tags of the CQEs received by the driver 504. The threshold value may be set to the sequence number of the last TCP segment that was copied to the user application 506. If the number of bytes of incoming TCP segments that were copied to the user application 506 is above the threshold value, the updated advertised window size along with the number of bytes of incoming TCP segments that were copied to the user application 506 is passed to the CNIC 502. The advertised window update in the driver 504 may be delayed till the return of all reported completed buffers or till all reported completions are copied to the user application 506.

The aggregate block 518 may be enabled to pass the current updated advertised window size to the receiver and the aggregate block 512. The aggregate block 512 may be enabled to aggregate the number of bytes of incoming TCP segments that were copied to the user application 506. The aggregate block 508 may be enabled to aggregate a plurality of bytes of incoming TCP segments that have been placed to the host memory 106.

The estimator 516 may be enabled to generate a completion threshold value based on the received Placement_SN and Window_Upd_SN values, where Placement_SN may indicate a number of bytes of incoming TCP segments that have been placed to the host memory 106 and Window_Upd_SN may indicate a number of bytes of incoming TCP segments that were copied to the user application 506.

The completion threshold value may be generated as follows: Initially the completion threshold value may be set to a minimum value, for example, 0. A temporary pending value (tmp_pending) may be determined using the following exemplary pseudocode:

```
tmp_pending = 32cyclic(Placement_SN − Window_Upd_SN)
If (completion threshold value < tmp_pending/2)
    completion threshold value += minimum
(COMP_THRESHOLD_STEP, completion threshold value −
tmp_pending/2)
Else
    completion threshold value = minimum
(connection_max_adv_window_size/4, completion threshold value)
```

where connection_max_adv_window_size is a maximal value of a connection number and may be adjusted based on connection receive window types, COMP_THRESHOLD_STEP may be threshold value, for example, 4096 bytes. The estimator 516 may be enabled to pass the generated completion threshold value to the threshold block 514.

In accordance with an embodiment of the invention, a connection completion or delivery of a plurality of bytes of incoming TCP segments that have been placed to the host memory 106 but have not yet been delivered to a user application 506 may be delayed in the chip, for example, CNIC 502 until a counter or a count such as a pending bytes count reaches a threshold value or a timeout value. The pending bytes count may comprise the plurality of bytes of incoming TCP segments that have been placed to the host memory 106 but have not yet been delivered to the user application 506.

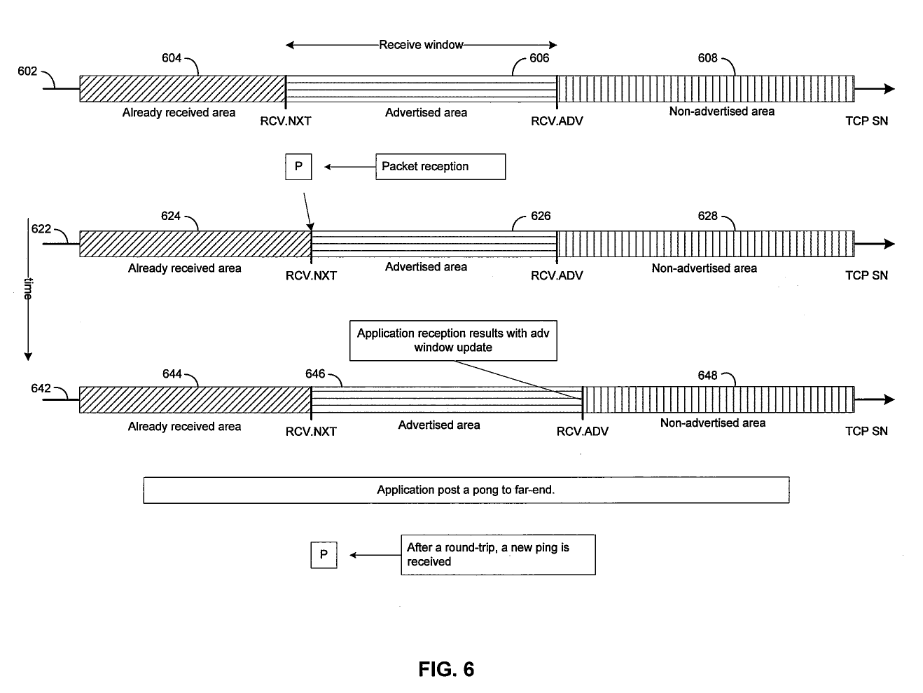

FIG. 6 is a block diagram illustrating updating of exemplary TCP parameters during a ping-pong test, in accordance with an embodiment of the invention. Referring to FIG. 6, there is shown a plurality of TCP window types over time periods 602, 622 and 642.

The receive next pointer (RCV.NXT) may indicate the sequence number of the next byte of data that may be expected from the receiver. The RCV.NXT pointer may indicate a dividing line between already received and acknowledged data, for example, already received area 604 and advertised area 606. A receive window may indicate a size of the receive window advertised to the receiver, for example, advertised area 604. The advertised area 604 may refer to a number of bytes the receiver is willing to accept at one time from its peer, which may be equal to the size of the buffer allocated for receiving data for this connection. The receive advertise (RCV.ADV) pointer may indicate the first byte of the non-advertised area 608 and maybe obtained by adding the receive window size to the RCV.NXT pointer.

In time period 602, when a transmitter is limited by a number of pending pings or a single pending ping, the receive window size, for example, the advertised area 606 may not be closed but may be maintained at a constant value, for example. In time period 622, a packet P with TCP PUSH may be received at RCV.NXT. The already received area 624 increases as RCV.NXT pointer shifts by packet P size to the right and the advertised area 626 may shrink as the RCV.ADV pointer may shift to the right after the incoming packet is copied to the user application 506 and the buffer is freed. When the transmitter is not limited by a number of pending pings but may be limited due to the advertising window, for example, the advertised area 626 of the far-end or the receiver which may be CPU limited, the receive window size, for example, the advertised area 626 may be shrunk.

In time period 642, the data may be copied to the user application 506 and the RCV. ADV pointer may shift to the right by packet P size increasing the advertised area 646 to its original size, for example, advertised area 606. The user application 506 may be enabled to update the advertised window size, for example, advertised area 646 and communicate the updated advertised window size to the driver 504.

When a receiver receives data from a transmitter, the receiver may place the data into a buffer. The receiver may then send an acknowledgement back to the transmitter to indicate that the data was received. The receiver may then process the received data and transfer it to a destination application process. In certain cases, the buffer may fill up with received data faster than the receiving TCP may be able to empty it. When this occurs, the receiver may need to adjust the window size to prevent the buffer from being overloaded. The TCP sliding window mechanism may be utilized to ensure reliability through acknowledgements, retransmissions and/or a flow control mechanism. A device, for example, the receiver may be enabled to increase or decrease a size of its receive window, for example, advertised area 606 at which its connection partner, for example, the transmitter sends it data. The receiver may reduce the receive window size, for example, advertised area 606 to zero, of the transmitter if the receiver becomes extremely busy. This may close the TCP window and halt any further transmissions of data until the window is reopened.

In a ping-pong test, a transmitter may send a ping to the receiver. The receiver may receive the ping and send a pong back to the transmitter in response to receiving the ping from the transmitter. The transmitter may then send another ping to the receiver in response to receiving a pong from the receiver.

According to RFC-793, “the data that flows on a connection may be thought of as a stream of octets. The sending user application indicates in each SEND call whether the data in that call (and any preceding calls) should be immediately pushed through to the receiving user application by the setting of the PUSH flag. A sending TCP is allowed to collect data from the sending user application and to send that data in segments at its own convenience, until the push function is signaled, then it must send all unsent data. When a receiving TCP sees the PUSH flag, it must not wait for more data from the sending TCP before passing the data to the receiving process.”

In a ping-pong test, the sender application may have to post its pings with PUSH indication. However, there may be certain non-Ping-Pong applications that may use PUSH as an upper layer boundary indication. The delayed completion algorithm does not violate RFC-793 as it delays the delivery or it does not wait for more data till its delivery and may be enforced by using the threshold timeout value.

In accordance with an embodiment of the invention, the delayed completion scheme may be applied to non-ping-pong cases. The delayed completion algorithm may be applied in a ping-ping test, for example, and may involve a number of outstanding pings or in a TCP stream where PUSH may indicates upper layer boundaries. The ping-pong test may involve more than a single pending ping.

In accordance with an embodiment of the invention, if one of the incoming TCP segments is received with TCP PUSH ON, an updated delayed completion algorithm may be utilized. The aggregate block 508 may be enabled to aggregate a plurality of bytes of incoming TCP segments that have been placed in the host memory 106 but have not yet been delivered to a user application 506. The threshold block 514 may comprise a completion threshold value. If the number of aggregated plurality of bytes of TCP segments in the aggregate block 508 is below the completion threshold value, the aggregate block 508 may continue to aggregate the plurality of plurality of bytes of incoming TCP segments. The CNIC 502 may generate a completion queue element (CQE) to the driver 504 if the following condition is satisfied:

If (pending_bytes>completion threshold value) OR [(push_flag==TRUE) AND (receive window size>connection_max_adv_window_size*constant value)]

where pending_bytes may indicate a plurality of bytes of incoming TCP segments that have been placed to the host memory 106 but have not yet been delivered to a user application 506, constant value may be a suitable fraction, for example, ¾ and receive window size may be, for example, the advertised area 626.

When completion aggregation is performed in the CNIC 502, the aggregation may be performed before host coalescing compared to when completion aggregation is performed in the driver 504, the aggregation may be performed after the interrupt or host coalescing. An advantage of performing completion coalescing in the CNIC 502 on a per connection basis is that it may solve the L4 host coalescing rate issue. For example, instead of sets of manual values for host coalescing threshold, where each of these values may optimize different benchmarks, the per connection completion coalescing in the CNIC 502 may result in an interrupt rate that may fit the running connection on per connection basis per connection benchmark.

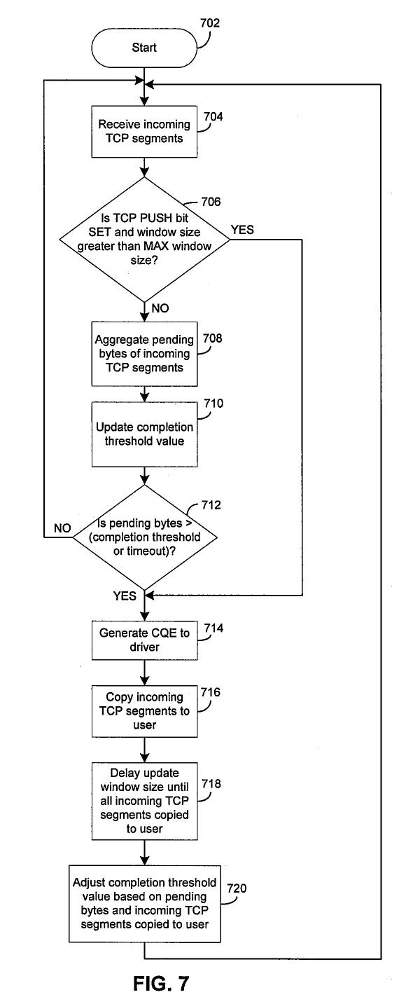

FIG. 7 is a flowchart illustrating exemplary steps for delayed completion coalescing, in accordance with an embodiment of the invention. Referring to FIG. 7, exemplary steps may begin at step 702. In step 704, the CNIC 502 may be enabled to receive one or more incoming TCP segments.

In step 706, it may be determined whether one of the incoming TCP segments is received with a TCP PUSH bit SET and the TCP receive window size is greater than a particular window size value, for example, a maximal value of a connection number (connection_max_adv_window_size) which may be adjusted based on connection receive window types. If one of the incoming TCP segments is received with a TCP PUSH bit SET and the TCP receive window size is greater than the particular window size value, control passes to step 714. If one of the incoming TCP segments is not received with a TCP PUSH bit SET or the TCP receive window size is not greater than the particular window size value, control passes to step 708.

In step 708, the CNIC 502 may be enabled to aggregate a plurality of bytes of incoming TCP segments that have been placed to the host memory 106 but have not yet been delivered to a user application 506. In step 710, the completion threshold value may be updated. In step 712, it may be determined whether a plurality of bytes of incoming TCP segments that have been placed to the host memory 106 but have not yet been delivered to a user application 506 is greater than or equal to the updated completion threshold value or a timeout value. If a plurality of bytes of incoming TCP segments that have been placed to the host memory 106 but have not yet been delivered to a user application 506 is not greater than or equal to the updated completion threshold value or a timeout value, control returns to step 704.

If a plurality of bytes of incoming TCP segments that have been placed to the host memory 106 but have not yet been delivered to a user application 506 is greater than or equal to the updated completion threshold value or a timeout value, control passes to step 714. In step 714, the CNIC 502 may be enabled to generate a CQE to the driver 504. In step 716, the driver may copy a plurality of incoming TCP segments to the user application 506. In step 718, the driver 504 may be enabled to delay an update of a TCP receive window size until one of the incoming TCP segments corresponding to a particular sequence number is copied to the user application 506. The particular sequence number may correspond to the last incoming TCP segment copied to the user application 506.

In step 720, the completion threshold value may be dynamically adjusted based on a comparison between the plurality of bytes of incoming TCP segments placed to the buffer in host memory 106 and the plurality of bytes of incoming TCP segments copied to the user application 506. Control then returns to step 704.

In accordance with an embodiment of the invention, a method and system for delayed completion coalescing may comprise accumulating a plurality of bytes of incoming TCP segments in a host memory 106 until a number of the plurality of bytes of incoming TCP segments reaches a completion threshold value. For example, the CNIC 502 may be enabled to delay a plurality of bytes of incoming TCP segments placed in a buffer in host memory 106 but not yet delivered to a user application 506 until the plurality of bytes reaches a completion threshold value. The plurality of bytes of incoming TCP segments in the host memory 106 may be accumulated until a time period of accumulation reaches a timeout value. The CNIC 502 may be enabled to generate a CQE to the driver 504 when the plurality of bytes of the incoming TCP segments placed in the buffer in host memory 106 but not yet delivered to the user application 506 reaches the completion threshold value or the accumulation time period reaches the timeout value. The plurality of bytes of incoming TCP segments in host memory 106 may be copied to a user application 506 based on the generation of the CQE.

In accordance with an embodiment of the invention, a method and system for delayed completion coalescing may comprise a CNIC 502 that may be enabled to implement TCP. The CNIC 502 may have a context of the TCP connections. The CNIC 502 may be enabled to utilize the connection contexts in order to perform estimations and decisions regarding placement and delivery of incoming TCP segments.

The completion threshold value may be dynamically adjusted based on a comparison between the plurality of bytes of incoming TCP segments placed in the buffer in host memory 106 and the plurality of bytes of incoming TCP segments copied to the user application 506. The driver 504 may be enabled to delay an update of a TCP receive window size until one of the incoming TCP segments corresponding to a particular sequence number is copied to the user application 506. The particular sequence number may correspond to the last incoming TCP segments copied to the user application 506.

The CNIC 502 may be enabled to generate the CQE to the driver 504 when at least one of the incoming TCP segments is received with a TCP PUSH bit SET and the TCP receive window size is greater than a particular window size value, for example, a maximal value of a connection number (connection_max_adv_window_size) which may be adjusted based on connection receive window types.

Another embodiment of the invention may provide a machine-readable storage, having stored thereon, a computer program having at least one code section executable by a machine, thereby causing the machine to perform the steps as described herein for delayed completion coalescing.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data, the method comprising:
accumulating a plurality of bytes of incoming TCP segments in a host memory until a number of said plurality of bytes of said incoming TCP segments reaches a threshold value; and
generating a completion queue entry (CQE) to a driver when said plurality of bytes of said incoming TCP segments reaches said threshold value.

2. The method according to claim 1, comprising copying said plurality of bytes of said incoming TCP segments in said host memory to an application based on said generation of said CQE.

3. The method according to claim 2, comprising dynamically adjusting said threshold value based on a comparison between said plurality of bytes of said incoming TCP segments accumulated in said host memory and said plurality of bytes of said incoming TCP segments copied to said application.

4. The method according to claim 2, comprising delaying in said driver, an update of a TCP receive window size until one of said incoming TCP segments corresponding to a particular sequence number is copied to said application.

5. The method according to claim 4, wherein said particular sequence number corresponds to a last of said incoming TCP segments copied to said application.

6. The method according to claim 4, comprising generating said CQE to said driver when at least one of said incoming TCP segments is received with a TCP PUSH bit SET and said TCP receive window size is greater than a particular window size value.

7. The method according to claim 1, comprising accumulating said plurality of bytes of said incoming TCP segments in said host memory until a time period of said accumulating reaches a timeout value.

8. The method according to claim 7, comprising generating said CQE to said driver when said time period of said accumulating reaches said timeout value.

9. A system for processing data, the system comprising:
one or more circuits that enables accumulation of a plurality of bytes of incoming TCP segments in a host memory until a number of said plurality of bytes of said incoming TCP segments reaches a threshold value; and
said one or more circuits enables generation of a completion queue entry (CQE) to a driver when said plurality of bytes of said incoming TCP segments reaches said threshold value.

10. The system according to claim 9, wherein said one or more circuits enables copying of said plurality of bytes of said incoming TCP segments in said host memory to an application based on said generation of said CQE.

11. The system according to claim 10, wherein said one or more circuits enables dynamic adjustment of said threshold value based on a comparison between said plurality of bytes of said incoming TCP segments accumulated in said host memory and said plurality of bytes of said incoming TCP segments copied to said application.

12. The system according to claim 10, wherein said one or more circuits in said driver enables delaying of an update of a TCP receive window size until one of said incoming TCP segments corresponding to a particular sequence number is copied to said application.

13. The system according to claim 12, wherein said particular sequence number corresponds to a last of said incoming TCP segments copied to said application.

14. The system according to claim 12, wherein said one or more circuits enables generation of said CQE to said driver when at least one of said incoming TCP segments is received with a TCP PUSH bit SET and said TCP receive window size is greater than a particular window size value.

15. The system according to claim 9, wherein said one or more circuits enables accumulation of said plurality of bytes of said incoming TCP segments in said host memory until a time period of said accumulation reaches a timeout value.

16. The system according to claim 15, wherein said one or more circuits enables generation of said CQE to said driver when said time period of said accumulation reaches said timeout value.

17. A machine-readable storage having stored thereon, a computer program having at least one code section for processing data, the at least one code section being executable by a machine for causing the machine to perform steps comprising:
accumulating a plurality of bytes of incoming TCP segments in a host memory until a number of said plurality of bytes of said incoming TCP segments reaches a threshold value; and
generating a completion queue entry (CQE) to a driver when said plurality of bytes of said incoming TCP segments reaches said threshold value.

18. The machine-readable storage according to claim 17, wherein said at least one code section comprises code for copying said plurality of bytes of said incoming TCP segments in said host memory to an application based on said generation of said CQE.

19. The machine-readable storage according to claim 18, wherein said at least one code section comprises code for dynamically adjusting said threshold value based on a comparison between said plurality of bytes of said incoming TCP segments accumulated in said host memory and said plurality of bytes of said incoming TCP segments copied to said application.

20. The machine-readable storage according to claim 18, wherein said at least one code section comprises code for delaying in said driver, an update of a TCP receive window size until one of said incoming TCP segments corresponding to a particular sequence number is copied to said application.

21. The machine readable storage according to claim 20, wherein said particular sequence number corresponds to a last of said incoming TCP segments copied to said application.

22. The machine-readable storage according to claim 20, wherein said at least one code section comprises code for generating said CQE to said driver when at least one of said incoming TCP segments is received with a TCP PUSH bit SET and said TCP receive window size is greater than a particular window size value.

23. The machine-readable storage according to claim 17, wherein said at least one code section comprises code for accumulating said plurality of bytes of said incoming TCP segments in said host memory until a time period of said accumulating reaches a timeout value.

24. The machine-readable storage according to claim 23, wherein said at least one code section comprises code for generating said CQE to said driver when said time period of said accumulating reaches said timeout value.
